(19) United States
(12) Patent Application Publication
(10) Pub. No.: US 2008/0028761 A1
(43) Pub. Date: Feb. 7, 2008

(54) Temperature equilibrating methodology & installation with water supply system

(76) Inventor: Tai-Her Yang, Si-Hu Town (TW)

Correspondence Address: BACON & THOMAS, 4th Floor, 625 Slaters Lane, Alexandria, VA, 22314-1176, US

(21) Appl. No.: 11/489,542

(22) Filed: Jul. 20, 2006

Related U.S. Application Data
(63) Continuation-in-part of application No. 11/442,265, filed on May 30, 2006.

(51) Int. Cl. F03G 7/04; B60H 1/22

(52) U.S. Cl. 60/641.6; 237/12

(57) ABSTRACT

A closed piping comprised of ground water pipe of a water supply system buried in the stratum and a closed water pipe provided on the ground to execute thermal conduction for equilibrating temperature from the thermal energy in the deeper stratum to a subject matter on the ground by the current running in the closed water pipes.

### CROSS-REFERENCES TO RELATED APPLICATION

This application is a Continuation-In-Part of my patent application, Ser. No. 11/442,265, filed on May 30, 2006.

### BACKGROUND OF THE INVENTION

(a) Field of the Invention

The present invention is related to a methodology and installation for temperature equilibrating conduction, and more particularly, to the use of specific piping from a water supply system and the water running in the pipe as a carrier to conduct the thermal energy in the stratum to a subject matter on the ground.

(b) Description of the Prior Art

Whereas reliance upon air conditioning system in summer time in conventional buildings and upon electric power or fuel for heating purpose in winter time consume massive energy source. Furthermore, in bitter cold days, frozen water pipe of the conventional water supply system exposed or buried just beneath the surface of the earth, accumulation of snow on roof and frozen road are often blamed for causing disasters.

### SUMMARY OF THE INVENTION

The primary purpose of the present invention is to provide a methodology and installation to execute temperature equilibration thermal transmission between the thermal energy in the deeper stratum and a subject matter on the ground designated for transmission of thermal energy by a closed piping comprised of underground water pipe buried in the underground for a water supply system and a closed water pipe disposed on the ground to transmit the thermal energy in the stratum conducted by the underground pipe through the current running in the closed water pipe.

### BRIEF DESCRIPTION OF THE DRAWINGS

FIG. 1 is a schematic view showing a layout of a conventional water supply piping and a piping in a building.

FIG. 2 is a schematic view of the present invention applied in a functional system of thermal equilibration in a building.

FIG. 3 is a schematic view showing that the present invention is applied in a construction of a temperature equilibration functional system in shallow stratum.

FIG. 4 is a schematic view showing that the present invention is applied in a construction of a temperature equilibration functional system exposed from a subject matter on the surface of the earth.

FIG. 5 is a schematic view showing that the present invention is applied in a construction of a temperature equilibration functional system in a structure on the top of a building.

FIG. 6 is a schematic view showing that the present invention is applied in a construction of an exposed temperature equilibration functional system on top of a building.

FIG. 7 is a schematic view of another preferred embodiment yet of the present invention showing that a system of a cladding chamber structure for temperature equilibration is provided to perform open fluid circulation to an open space.

FIG. 8 is a schematic view of another preferred embodiment yet of the present invention showing that the system includes the cladding chamber structure for temperature equilibration to perform open fluid circulation to an interior space in a building or other closed or semi-closed structure.

FIG. 9 is a schematic view of another preferred embodiment yet of the present invention showing that the system includes the cladding chamber structure for temperature equilibration to perform closed fluid circulation to an open space.

FIG. 10 is a schematic view of another preferred embodiment yet of the present invention showing that the system includes the cladding chamber structure for temperature equilibration to perform closed fluid circulation to an interior space in a building or other closed or semi-closed structure.

FIG. 11 is a schematic view of another preferred embodiment yet of the present invention showing that the system includes an auxiliary temperature equilibration piping disposed in parallel to the present invention so to perform open fluid temperature equilibration circulation to an open space.

FIG. 12 is a schematic view of another preferred embodiment yet of the present invention showing that the water supply system is disposed with an auxiliary temperature equilibration piping in parallel to the present invention so to perform open fluid circulation to the interior space in a building or other closed or semi-closed structure.

FIG. 13 is a schematic view of another preferred embodiment yet of the present invention showing that the water supply system is disposed with an auxiliary temperature equilibration piping in parallel to the present invention so to perform closed fluid circulation to an open space.

FIG. 14 is a schematic view of another preferred embodiment yet of the present invention showing that the water supply system is disposed with an auxiliary temperature equilibration piping in parallel to the present invention so to perform closed fluid circulation to the interior space in a building or other closed or semi-closed structure.

### DETAILED DESCRIPTION OF THE PREFERRED EMBODIMENTS

The present invention of methodology and installation for temperature equilibration by means of a water supply system operates on having an underground water pipe of the conventional water supply system buried in the stratum and water running in the pipe as carriers to be incorporated with a flow passage comprised of a closed water pipe constructed on the ground, a temperature equilibrating object, and a pump. Whereas it is a well-known fact that the stratum 4˜6 meters below the surface of the earth maintains a normal temperature range between 12˜16□ all year round, the current pumped by the pump, or the circulating current resulted from the convection effect due to temperature difference when the hotter water runs to the cooler water and vice versa, or the current resulted from shunting effect, functions in the present invention as a carrier of thermal energy to execute thermal transmission of temperature equilibration between the thermal energy in the stratum and a subject matter on ground to receive the thermal energy transmission, thus to replace or support the conventional air conditioning system that consumes massive energy and further to save energy.

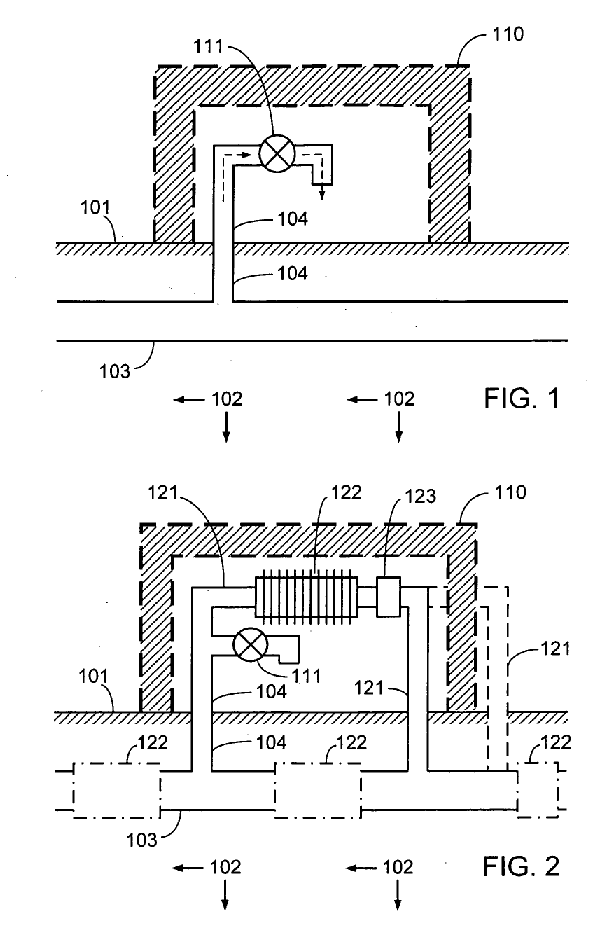

Referring to FIG. 1 for a layout of a conventional water supply piping and a piping of a building, wherein,
101 relates to the surface of the earth;
102 relates to a deeper stratum where the normal temperature maintains within the range of 12˜16□;
103 relates to an underground water pipe of a conventional water supply system buried in the deeper stratum 102;
104 relates to a water supply branch to be connected to where between a water valve 111 at the subscriber's and the underground water pipe 103 to deliver water from the water supply system to the subscriber; and
111 relates to the water valve at the subscriber's building 110 that serves as a flow switch to fetch the water at random.

Within the layout as described above, the following problems often take place in bitter cold winter:

(1) The water inside the conventional water supply branch 104 that is closer to the surface of the earth 101 or that is exposed from the surface of the earth 101 is vulnerable to get frozen in bitter cold winter thus to block the current; and

(2) The roof of the building is sometimes threatened by collapse due to the weight and pressure imposed by accumulated snow or ice thereon.

The temperature equilibrating methodology and installation by means of the water supply system of the present invention is innovative to provide closed water pipe in a building for the thermal energy in the stratum absorbed by the underground water pipe buried in the stratum to execute thermal transmission of thermal equilibration to the perimeters of the closed water pipe or the temperature equilibration installation in the building through a flow passage created by the thermal equilibration installation, fluid pump and the underground water pipe buried in the stratum with the circulation current as the carrier.

FIG. 2 is a schematic view of the present invention applied in a functional system of thermal equilibration in a building. Wherein, the present invention is essentially comprised of:
an underground water pipe 103: buried in a deeper stratum 102 for transmission of current in the water supply system; the structure of the underground water pipe 103 may be in conventional form of pipe or in any geometric shape that facilitates heat transmission, and is made of material that provides good heat conduction such as metal or other heat conduction material to directly conduct the thermal energy in the stratum from the underground water pipe 103; furthermore, an optional item of temperature equilibrating installation 122 may be disposed in series with the underground water pipe 103 to improve conduction of the thermal energy in the stratum;
a closed water pipe 121: related to a closed current piping, may be structured in a conventional pipe form or any geometric shape and material that facilitates heat transmission, and disposed at where even closer to a surface of the earth 101 than that by the underground water pipe 103, where exposed from the surface of the earth 101, on top in a building 110, or in a selected space closer to the ground or to a wall; the inlet of the closed water pipe 121 is connected to the underground water pipe 103 to introduce the current from the underground water pipe 103 to flow through another section of the underground water pipe 103 connected to the outlet of the closed water pipe 121 before flowing back into the underground water pipe 103 to complete the flow passage in executing heat transmission of temperature equilibration by current; furthermore, an optional temperature equilibrating installation 122 and an optional pump 123 to pump the current may be provided in series as applicable;
the temperature equilibrating installation 122: made of material with good heat conduction structured in a geometric shape that facilitates heat conduction, includes a water inlet and water passage in the temperature equilibrating installation 122, and a water outlet; connected in series with the closed water pipe 121 in a building 110 or with the underground water pipe 103 to execute heat transmission of temperature equilibration with the thermal energy of the water passing by and that from the perimeter of the temperature equilibrating installation 122; the temperature equilibrating installation may be provided as applicable to be connected in series to the underground water pipe 103 and/or the closed water pipe 121 in the building 110, or not provided at all; and
a pump 123: to pump the water flow to transmit thermal energy; may be of reciprocal or circulating pump driven by external force; the external force being selected according to the working environment includes the mechanical energy or the electric power converted from the mechanical energy generated from power motor, engine power, other wind velocity energy, thermal energy, temperature difference energy, or solar energy; furthermore, the pump 123 relates to an optional item to be provided or not provided as applicable.

Furthermore, the methodology and installation of temperature equilibration with the water supply system of the present invention can be also applied to open public facilities. It is a well-known fact that the underground water pipe of a water supply system is usually buried under a highway or other open public facilities and the accumulation of snow on highway or frozen highway will frustrate transportation. The methodology and installation of temperature equilibration with the water supply system of the present invention may be also applied in the temperature equilibrating transmission on the surface of the earth in shallow stratum of a highway, or in exposed temperature equilibrating transmission at open public place.

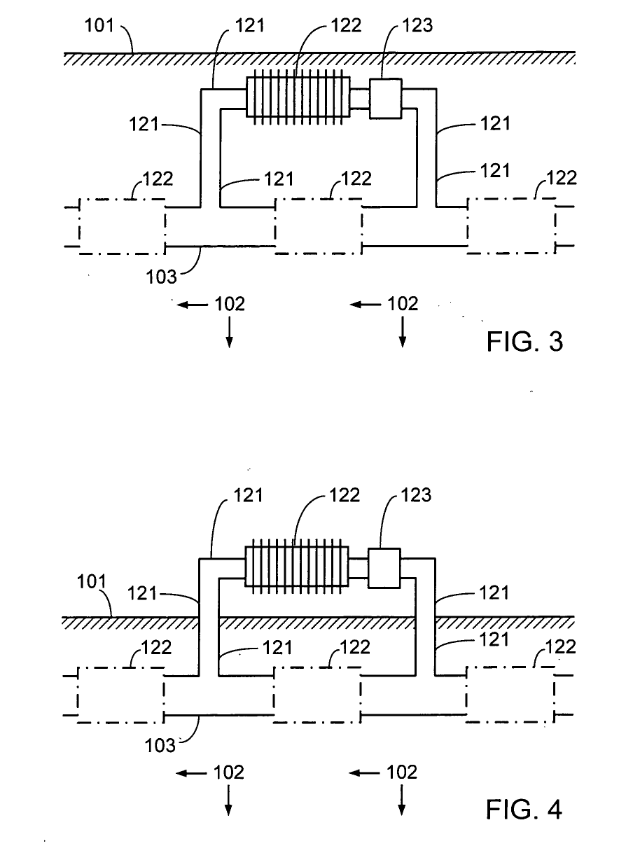

FIG. 3 is a schematic view showing that the present invention is applied in a construction of a temperature equilibration functional system in shallow stratum. The present invention is essentially comprised of:
an underground water pipe 103: buried in a deeper stratum 102 for transmission of current in the water supply system; the structure of the underground water pipe 103 may be in conventional form of pipe or in any geometric shape that facilitates heat transmission, and is made of material that provides good heat conduction such as metal or other heat conduction material to directly conduct the thermal energy in the stratum from the underground water pipe 103; furthermore, an optional item of temperature equilibrating installation 122 may be disposed in series with the underground water pipe 103 to improve conduction of the thermal energy in the stratum;
a closed water pipe 121: related to a closed current piping, may be structured in a conventional pipe form or any geometric shape and material that facilitates heat transmission, and disposed at where even closer to a surface of the earth 101 than that by the underground water pipe 103; the inlet of the closed water pipe 121 is connected to the underground water pipe 103 to introduce the current from the underground water pipe 103 to flow through another section of the underground water pipe 103 connected to the outlet of the closed water pipe 121 before flowing back into the underground water pipe 103 to complete the flow passage in executing heat transmission of temperature equilibration by current; furthermore, an optional temperature equilibrating installation 122 and an optional pump 123 to pump the current may be provided in series as applicable;
the temperature equilibrating installation 122: made of material is with good heat conduction structured in a geometric shape that facilitates heat conduction, includes a water inlet and water passage in the installation 122, and a water outlet; connected in series with the closed water pipe 121 or with the underground water pipe 103 to execute heat transmission of temperature equilibration with the thermal energy of the water passing by and that from the perimeter of the temperature equilibrating installation 122; the temperature equilibrating installation may be provided as applicable to be connected in series to the underground water pipe 103 and/or the closed water pipe 121 in the building 110, or not provided at all; and
a pump 123: to pump the water flow to transmit thermal energy; may be of reciprocal or circulating pump driven by external force; the external force being selected according to the working environment includes the mechanical energy or the electric power converted from the mechanical energy generated from power motor, engine power, other wind velocity energy, thermal energy, temperature difference energy, or solar energy; furthermore, the pump 123 relates to an optional item to be provided or not provided as applicable.

FIG. 4 is a schematic view showing that the present invention is applied in a construction of a temperature equilibration functional system exposed from a subject matter on the surface of the earth. The present invention is essentially comprised of:
an underground water pipe 103: buried in a deeper stratum 102 for transmission of current in the water supply system; the structure of the underground water pipe 103 may be in conventional form of pipe or in any geometric shape that facilitates heat transmission, and is made of material that provides good heat conduction such as metal or other heat conduction material to directly conduct the thermal energy in the stratum from the underground water pipe 103; furthermore, an optional item of temperature equilibrating installation 122 may be disposed in series with the underground water pipe 103 to improve conduction of the thermal energy in the stratum;
a closed water pipe 121: related to a closed current piping, may be structured in a conventional pipe form or any geometric shape and material that facilitates heat transmission, and disposed at where exposed from the surface of the earth 101; the inlet of the closed water pipe 121 is connected to the underground water pipe 103 to introduce the current from the underground water pipe 103 to flow through another section of the underground water pipe 103 connected to the outlet of the closed water pipe 121 before flowing back into the underground water pipe 103 to complete the flow passage in executing heat transmission of temperature equilibration by current; furthermore, an optional temperature equilibrating installation 122 and an optional pump 123 to pump the current may be provided in series as applicable;
the temperature equilibrating installation 122: made of material with good heat conduction structured in a geometric shape that facilitates heat conduction, includes a water inlet and water passage in the temperature equilibrating installation 122, and a water outlet; connected in series with the closed water pipe 121 or with the underground water pipe 103 to execute heat transmission of temperature equilibration with the thermal energy of the water passing by and that from the perimeter of the temperature equilibrating installation 122; the temperature equilibrating installation 122 may be provided as applicable to be connected in series to the underground water pipe 103 and/or the closed water pipe 121 in the building 110, or not provided at all; and
a pump 123: to pump the water flow to transmit thermal energy; may be of reciprocal or circulating pump driven by external force; the external force being selected according to the working environment includes the mechanical energy or the electric power converted from the mechanical energy generated from power motor, engine power, other wind velocity energy, thermal energy, temperature difference energy, or solar energy; furthermore, the pump 123 relates to an optional item to be provided or not provided as applicable.

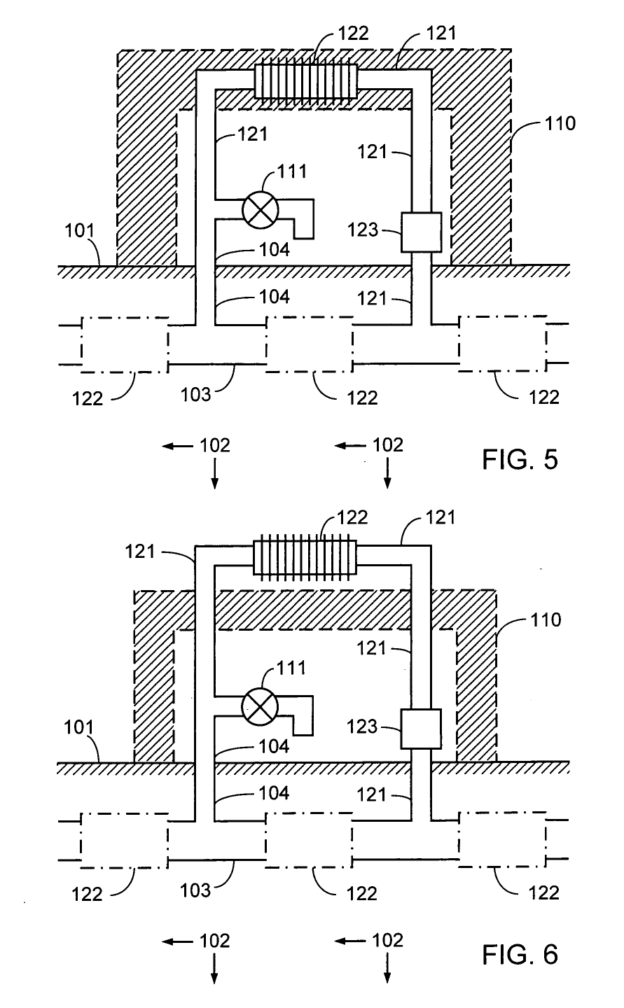

FIG. 5 is a schematic view showing that the present invention is applied in a construction of a temperature equilibration functional system in a structure on the top of a building. The present invention is essentially comprised of:
an underground water pipe 103: buried in a deeper stratum 102 for transmission of current in the water supply system; the structure of the underground water pipe 103 may be in conventional form of pipe or in any geometric shape that facilitates heat transmission, and is made of material that provides good heat conduction such as metal or other heat conduction material to directly conduct the thermal energy in the stratum from the underground water pipe 103; furthermore, an optional item of temperature equilibrating installation 122 may be disposed in series with the underground water pipe 103 to improve conduction of the thermal energy in the stratum;
a closed water pipe 121: related to a closed current piping, may be structured in a conventional pipe form or any geometric shape and material that facilitates heat transmission, and disposed in a structure on top of a building 110; the inlet of the closed water pipe 121 is connected to the underground water pipe 103 to introduce the current from the underground water pipe 103 to flow through another section of the underground water pipe 103 connected to the outlet of the closed water pipe 121 before flowing back into the underground water pipe 103 to complete the flow passage in executing heat transmission of temperature equilibration by current; furthermore, an optional temperature equilibrating installation 122 and an optional pump 123 to pump the current may be provided in series as applicable;
the temperature equilibrating installation 122: made of material with good heat conduction structured in a geometric shape that facilitates heat conduction, includes a water inlet and water passage in the temperature equilibrating installation 122, and a water outlet; connected in series with the closed water pipe 121 or with the underground water pipe 103 to execute heat transmission of temperature equilibration with the thermal energy of the water passing by and that from the perimeter of the temperature equilibrating installation 122; the temperature equilibrating installation 122 may be provided as applicable to be connected in series to the underground water pipe 103 and/or the closed water pipe 121 in the building 110, or not provided at all, and
a pump 123: to pump the water flow to transmit thermal energy; may be of reciprocal or circulating pump driven by external force; the external force being selected according to the working environment includes the mechanical energy or the electric power converted from the mechanical energy generated from power motor, engine power, other wind velocity energy, thermal energy, temperature difference energy, or solar energy; furthermore, the pump 123 relates to an optional item to be provided or not provided as applicable.

FIG. 6 is a schematic view showing that the present invention is applied in a construction of an exposed temperature equilibration functional system on top of a building. The present invention is essentially comprised of:
an underground water pipe 103: buried in a deeper stratum 102 for transmission of current in the water supply system; the structure of the underground water pipe 103 may be in conventional form of pipe or in any geometric shape that facilitates heat transmission, and is made of material that provides good heat conduction such as metal or other heat conduction material to directly conduct the thermal energy in the stratum from the underground water pipe 103; furthermore, an optional item of temperature equilibrating installation 122 may be disposed in series with the underground water pipe 103 to improve conduction of the thermal energy in the stratum;
a closed water pipe 121: related to a closed current piping, may be structured in a conventional pipe form or any geometric shape and material that facilitates heat transmission, and disposed at where exposed from the top of the building 110; the inlet of the closed water pipe 121 is connected to the underground water pipe 103 to introduce the current from the underground water pipe 103 to flow through another section of the underground water pipe 103 connected to the outlet of the closed water pipe 121 before flowing back into the underground water pipe 103 to complete the flow passage in executing heat transmission of temperature equilibration by current; furthermore, an optional temperature equilibrating installation 122 and an optional pump 123 to pump the current may be provided in series as applicable;
the temperature equilibrating installation 122: made of material with good heat conduction structured in a geometric shape that facilitates heat conduction, includes a water inlet and water passage in the installation 122, and a water outlet; connected in series with the closed water pipe 121 exposed from a top of a building 110 or with the underground water pipe 103 to execute heat transmission of temperature equilibration with the thermal energy of the water passing by and that from the perimeter of the temperature equilibrating installation 122; the temperature equilibrating installation may be provided as applicable to be connected in series to the underground water pipe 103 and/or the closed water pipe 121 exposed from the top of the building 110, or not provided at all, and
a pump 123: to pump the water flow to transmit thermal energy; may be of reciprocal or circulating pump driven by external force; the external force being selected according to the working environment includes the mechanical energy or the electric power converted from the mechanical energy generated from power motor, engine power, other wind velocity energy, thermal energy, temperature difference energy, or solar energy; furthermore, the pump 123 relates to an optional item to be provided or not provided as applicable.

The temperature equilibration effects of the methodology and installation of temperature equilibration with a water supply system of the present invention include:

(1) the temperature of the subject matter on the surface of the earth to receive transmission of thermal energy is reduced by the thermal energy of the stratum at comparatively lower temperature; and

(2) the temperature of the subject matter on the surface of the earth to receive transmission of thermal energy is raised by the thermal energy of the stratum at comparatively higher temperature.

The temperature equilibrating installation 122 of the methodology and installation of temperature equilibration with a water supply system of the present invention may be optionally provided as follows:

(1) to be provided in the underground floor and connected in series with the underground water pipe 103; or

(2) to be provided at where closer to or exposed from the surface of the earth and connected in series with the closed water pipe 121, or

(3) to be connected in series with both of the underground water pipe 103 and the closed water pipe 121; or

(4) not to be provided to either the underground water pipe 103 or the closed water pipe 121.

The temperature equilibrating installation 122 of the methodology and installation of temperature equilibration with a water supply system of the present invention may be provided or not by taking the site of application and cost benefits into consideration. In addition to providing the temperature equilibrating installation 122, the temperature equilibrating function may be achieved by the underground water pipe 103 or the closed water pipe 121 or the closed water pipe in lieu of the temperature equilibrating installation 122; or a structure providing good is thermal conduction performance is disposed other than the underground water pipe 103 or the closed water pipe 121 to promote temperature equilibrating function.

To upgrade the general efficiency, heat insulation material may be provided as required by the work environment or function between the underground water pipe 103 and the closed water pipe 121 exposed or closer to the surface of the earth 101 for the methodology and installation of temperature equilibration with a water supply system of the present invention, or the section of the closed water pipe 121 is made of heat insulation material to prevent loss of thermal energy.

The linking between the closed water pipe 121 and the underground water pipe 103 in the methodology and installation of temperature equilibration with a water supply system of the present invention may be as such that:

(1) The water inlet of the closed water pipe 121 is connected to the side of the upper stream; and the outlet, to the side of the lower stream of the underground water pipe 103, or

(2) The water inlet of the closed water pipe 121 is connected to the side of the lower stream; and the outlet, to the side of the upper stream of the underground water pipe 103.

Other than the pump 123 to pump current in the methodology and installation of temperature equilibration with a water supply system of the present invention to serve as an optional item to function as a carrier of thermal energy by taking the application site and cost benefits into consideration, the water convection effects may be applied to create circulating water, or the flowing force of the current in the underground water pipe 103 is used to create shunting effect for the water flowing through the closed water pipe 121 to serve as a carrier of thermal energy to execute heat transmission of temperature equilibration; in addition to being pumped by the pump 123, the current flowing through the closed water pipe 121 may be found with any of the following patterns:

(1) the convection effects due to the fact that the cooler water descends and the hotter water ascends that create circulating water to serve as the carrier of thermal energy to execute heat transmission of temperature equilibration; or

(2) by following the direction of the current in the underground water pipe, the current indicates a specific angle that indicates positive water pressure when introduced into the water inlet connected to the upper stream of the closed water pipe 121; e.g., indicating a sharp angle <90° against the current direction of the underground water pipe 103 thus to facilitate introducing the current into the closed water pipe 121 while indicating a specific angle with negative water pressure against the direction of the current of the underground water pipe 103, e.g., an obtuse angle >90° to facilitate the water flowing out of the outlets of the closed water pipe 121 and to converge with the underground water pipe 103 in creating the shunting effects for the current branching out of the closed water pipe 121 to serve a carrier of thermal energy in executing heat transmission of temperature equilibration; or

(3) by relying upon the pump to pump the current and/or water temperature difference flowing characteristics of the water and/or shunting effects, the water flowing through the closed water pipe 121 serves as the carrier of the thermal energy to execute heat transmission of temperature equilibration.

The methodology and installation of temperature equilibration with a water supply system of the present invention may be applied at the same time to incorporate a water supply branch 104 to the closed water pipe 121 for certain portion of the conventional water supply branch 104 to serve as a common water pipe to create a closed current flow passage sharing the same structure with certain portion of the closed water pipe 121. If the pump 123 will be provided to the closed current passage sharing the common structure, then

(1) the pump 123 is disposed to the closed water pipe 121; or

(2) the pump 123 is disposed to the common water pipe; or

(3) both of the closed water pipe 121 and the common water pipe are respectively provided with the pump 123; or

(4) the pump 123 is provided neither to the closed water pipe 121 nor to the common water pipe.

The methodology and installation of temperature equilibration with a water supply system of the present invention when adapted with the closed current passage sharing the common structure provide the following results and benefits:

(1) The flowing of the current bearing thermal energy from the stratum helps prevent the portion of the conventional water supply branch 104 close to and exposed from the surface of the earth 101 from getting frozen due to ambient temperature.

(2) The flowing of the current bearing thermal energy from the stratum helps cool down the interior temperature of a building in summer.

(3) The flowing of the current bearing thermal energy from the stratum helps maintain a temperature higher than that in the outer environment during the wintertime without the service of central heating; helps melting the accumulated snow on the roof and prevent getting frozen when applied in a warehouse.

A cladding chamber structure for temperature equilibration is further provided to the ground or underground water supply piping of the water supply system of the present invention. Indirectly through the interior of the cladding chamber, the thermal energy carried by the water current in the water supply piping flows to another gaseous or liquid state fluid of the subject matter into an open space, building, or other closed or semi-closed structure of the subject matter for temperature equilibration to perform the indirect transmission of thermal energy for the purpose of temperature equilibration.

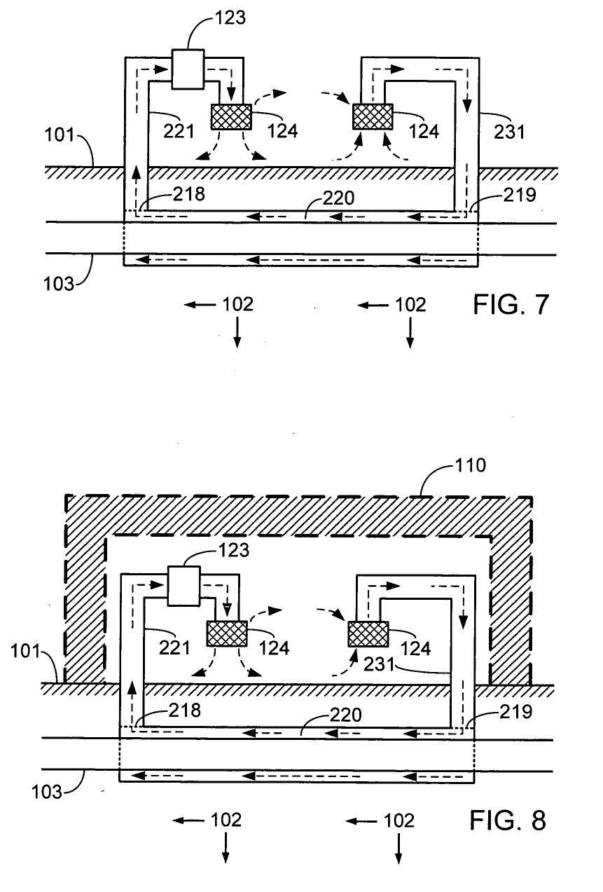

FIG. 7 shows a schematic view of another preferred embodiment yet of the present invention, wherein a system of a cladding chamber structure for temperature equilibration is provided to perform open fluid circulation to an open space.

The system includes a cladding chamber structure 220 for temperature equilibration disposed at where surrounds a certain section of the underground water pipe 103 of the water supply system; both end surfaces are closed to the cladding chamber structure 220 for temperature equilibration. One or a plurality of fluid inlet 218 and a fluid piping 221 leading to the open space are disposed at one end in the vicinity of the closed end surface; one or a plurality of fluid outlet 219 and a fluid piping 231 leading to the open space are disposed on the other end of the cladding chamber structure 220 to allow the gaseous or liquid state fluid flowing in and out. The fluid may perform convection circulation by the effects that the cooler descends and the hotter ascends, or driven by a motor with the installation of a liquid pump 123, or driven by other mechanical kinetics or by manual so to pump the fluid passing through the cladding chamber structure 220 into the fluid piping 221 to the open space. The fluid in the open space flows through the fluid piping 231 back to the cladding chamber structure 220 so to perform the temperature equilibration transmission of indirect conduction of thermal energy between the water supply system and the open space. The fluid piping 221 and another fluid piping 231 are respectively leading to the open space to perform the open fluid circulation; and the optional filtration device 124 may be each disposed to the fluid inlet and outlet of the fluid piping 221 and another fluid piping 231.

FIG. 8 shows a schematic view of another preferred embodiment yet of the present invention, wherein the system includes the cladding chamber structure for temperature equilibration to perform open fluid circulation to an interior space in a building or other closed or semi-closed structure.

The system includes a cladding chamber structure 220 for temperature equilibration disposed at where surrounds a certain section of the underground water pipe 103 of the water supply system; both end surfaces are closed to the cladding chamber structure 220 for temperature equilibration. One or a plurality of fluid inlet 218 and the fluid piping 221 leading to the space inside the closed or semi-closed structure in the building 110 are disposed at one end in the vicinity of the closed end surface; one or a plurality of fluid outlet 219 and a fluid piping 231 leading to the space inside the closed or semi-closed structure in the building 110 are disposed on the other end of the cladding chamber structure 220 to allow the gaseous or liquid state fluid flowing in and out. The fluid may perform convection circulation by the effects that the cooler descends and the hotter ascends, or driven by a motor with the installation of a liquid pump 123, or driven by other mechanical kinetics or by manual so to pump the fluid passing through the cladding chamber structure 220 into the fluid piping 221 to the space inside the building 110 or other closed or semi-closed structure. The fluid then flows through the fluid piping 231 back to the cladding chamber structure 220 so to perform the temperature equilibration transmission of indirect conduction of thermal energy between the water supply system and the space inside the building 110 or other closed or semi-closed structure. The fluid piping 221 and another fluid piping 231 are respectively leading to the interior space in the building 110 or other closed or semi-closed structure to perform the open fluid circulation; and the optional filtration device 124 may be each disposed to the fluid inlet and outlet of the fluid piping 221 and another fluid piping 231.

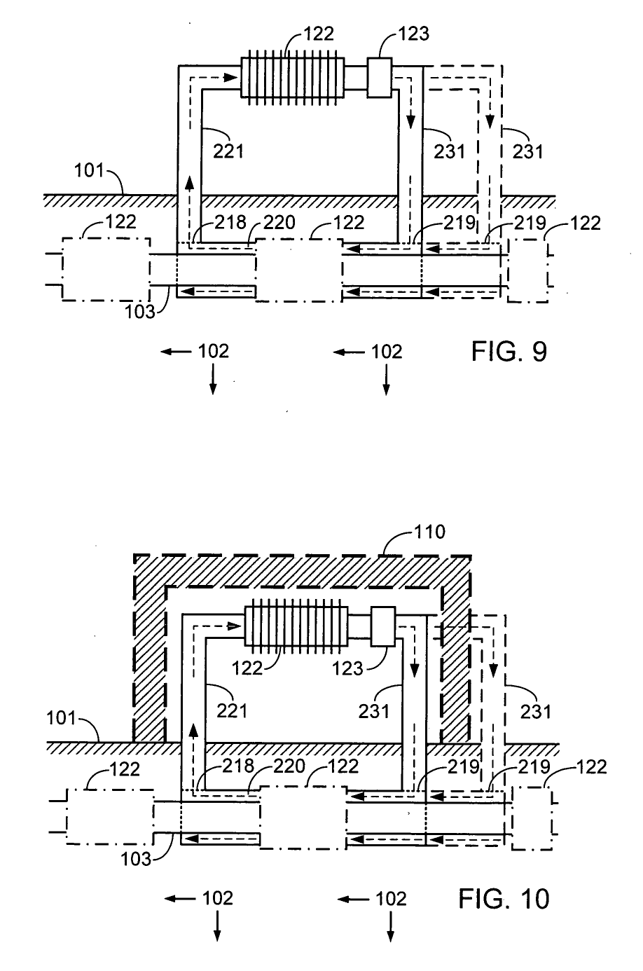

FIG. 9 shows a schematic view of another preferred embodiment yet of the present invention, wherein the system includes the cladding chamber structure for temperature equilibration to perform closed fluid circulation to an open space.

The system includes a cladding chamber structure 220 for temperature equilibration disposed at where surrounds a certain section of the underground water pipe 103 of the water supply system; both end surfaces are closed to the cladding chamber structure 220 for temperature equilibration. One or a plurality of fluid inlet 218 and the fluid piping 221 leading to the open space are disposed at one end in the vicinity of the closed end surface; one or a plurality of fluid outlet 219 and a fluid piping 231 leading to the open space are disposed on the other end of the cladding chamber structure 220 to allow the gaseous or liquid state fluid flowing in and out. The fluid may perform convection circulation by the effects that the cooler descends and the hotter ascends, or driven by a motor with the installation of a liquid pump 123, or driven by other mechanical kinetics or by manual so to pump the fluid passing through the cladding chamber structure 220 into the fluid piping 221 to the temperature equilibrating installation 122 disposed in the open space. The fluid then flows through the fluid piping 231 back to the cladding chamber structure 220 so to perform the temperature equilibration transmission of indirect conduction of thermal energy between the water supply system and the open space through temperature equilibrating installation 122. The fluid piping 221 and another fluid piping 231 are respectively leading to the temperature equilibrating installation 122 disposed in the open space to perform the closed fluid circulation for transmission of temperature equilibration.

FIG. 10 shows a schematic view of another preferred embodiment yet of the present invention, wherein the system includes the cladding chamber structure for temperature equilibration to perform closed fluid circulation to an interior space in a building or other closed or semi-closed structure.

The system includes a cladding chamber structure 220 for temperature equilibration disposed at where surrounds a certain section of the underground water pipe 103 of the water supply system; both end surfaces are closed to the cladding chamber structure 220 for temperature equilibration. One or a plurality of fluid inlet 218 and the fluid piping 221 leading to the interior space in a building 110 or a closed or semi-closed structure are disposed at one end in the vicinity of the closed end surface; one or a plurality of fluid outlet 219 and a fluid piping 231 leading to the interior space in a building 110 or a closed or semi-closed structure are disposed on the other end of the cladding chamber structure 220 to allow the gaseous or liquid state fluid flowing in and out. The fluid may perform convection circulation by the effects that the cooler descends and the hotter ascends, or driven by a motor with the installation of a liquid pump 123, or driven by other mechanical kinetics or by manual so to pump the fluid passing through the cladding chamber structure 220 into the fluid piping 221 to the temperature equilibrating installation 122 disposed in the interior space in the building 110 or other closed or semi-closed structure. The fluid then flows through the fluid piping 231 back to the cladding chamber structure 220 so to perform the temperature equilibration transmission of indirect conduction of thermal energy between the water supply system and the interior space in the building 110 or other closed or semi-closed structure through the temperature equilibrating installation 122. The fluid piping 221 and another fluid piping 231 are respectively leading to the temperature equilibrating installation 122 disposed in the interior space in the building 110 or other closed or semi-closed structure to perform the closed fluid circulation for transmission of temperature equilibration.

Alternatively, an auxiliary temperature equilibration piping may be included in the methodology and installation of temperature equilibration with a water supply system of the present invention to be disposed at where in parallel and allowing mutual transmission of thermal energy with the ground or the underground water supply piping. The auxiliary temperature equilibration piping is provided also to allow another type of gaseous or liquid state fluid passing through the piping to the subject matter to indirectly perform the temperature equilibration transmission with the subject matter by utilizing the thermal energy carried by the water current inside the water supply piping of the underground water supply system.

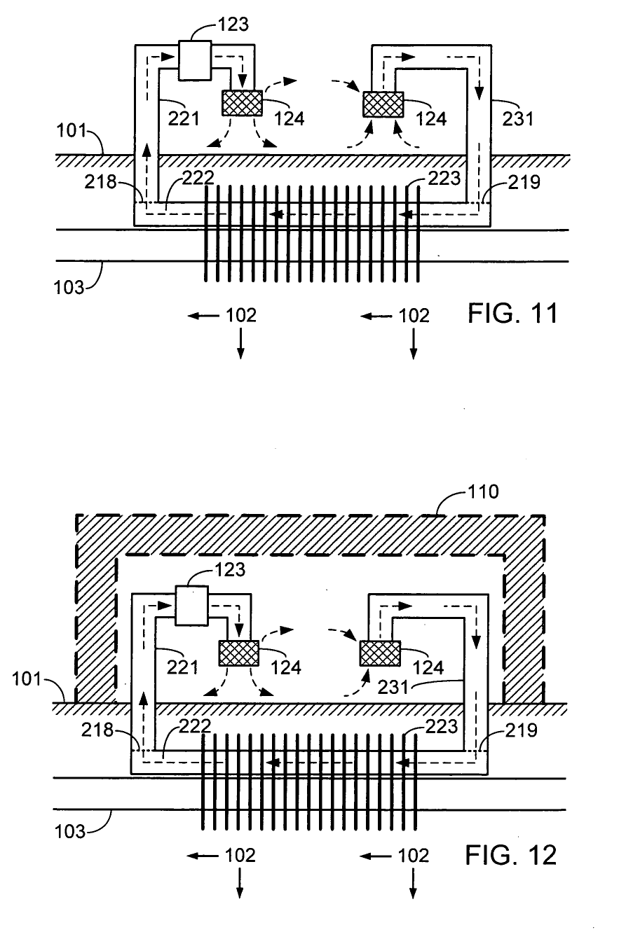

FIG. 11 shows a schematic view of another preferred embodiment yet of the present invention, wherein the system includes an auxiliary temperature equilibration piping disposed in parallel to the present invention so to perform open fluid temperature equilibration circulation to an open space.

The system includes one or a plurality of an auxiliary temperature equilibration piping 222 disposed in parallel with and to the perimeter of a certain section of the underground water pipe 103 of the water supply system that is capable of executing transmission of thermal energy mutually with the underground water pipe 103 of the water supply system, and both may be made to share the same construction or interlocked to each other if and when necessarily to facilitate the transmission of thermal energy; or alternatively, a wing shape structure 223 or any other heat conduction structure or heat pipe device may be disposed at where between the water supply system and the auxiliary temperature equilibration piping 222 so to indirectly perform the indirect transmission of thermal energy between the water current inside the underground piping 103 of the water supply system, and the fluid flowing through the auxiliary temperature equilibration piping 222. One or a plurality fluid inlet 218 and a fluid piping 221 leading to the open space are disposed to one end of the auxiliary temperature equilibration piping 222; and one or a plurality of fluid outlet 219 and a fluid piping 231 leading to the open space are disposed to the other end of the auxiliary temperature equilibration piping 222 for the gaseous or liquid state fluid to flow in and out. The fluid may perform convection circulation by the effects that the cooler descends and the hotter ascends, or driven by a motor with the installation of a liquid pump 123, or driven by other mechanical kinetics or by manual so to pump the fluid passing through the auxiliary temperature equilibration piping 222 into the fluid piping 221 to the open space. The fluid then flows through the fluid piping 231 back to the auxiliary temperature equilibration piping 222 so to indirectly perform the temperature equilibration transmission of indirect conduction of thermal energy between the water supply system and the open space. The fluid piping 221 and another fluid piping 231 are respectively leading to the open space to perform the open fluid circulation; and the optional filtration device 124 may be each disposed to the fluid inlet and outlet of the fluid piping 221 and another fluid piping 231.

FIG. 12 shows a schematic view of another preferred embodiment yet of the present invention, wherein the water supply system is disposed with an auxiliary temperature equilibration piping in parallel to the present invention so to perform open fluid circulation to the interior space in a building or other closed or semi-closed structure.

One or a plurality of auxiliary temperature equilibration piping 222 is disposed in parallel with and to the perimeter of a certain section of the underground water pipe 103 of the water supply system. The auxiliary temperature equilibration piping 222 is capable of executing transmission of thermal energy mutually with the underground water pipe 103 of the water supply system, and both may be made to share the same construction or interlocked to each other if and when necessarily to facilitate the transmission of thermal energy; or alternatively, a wing shape structure 223 or any other heat conduction structure or heat pipe device may be disposed at where between the water supply system and the auxiliary temperature equilibration piping 222 so to indirectly perform the indirect transmission of thermal energy between the water current inside the underground piping 103 of the water supply system and the fluid flowing though the auxiliary temperature equilibration piping 222. One or a plurality fluid inlet 218 and a fluid piping 221 leading to the interior space in the building 110 or other closed or semi-closed structure are disposed to one end of the auxiliary temperature equilibration piping 222; and one or a plurality of fluid outlet 219 and a fluid piping 231 leading to the interior space in the building 110 or a closed or semi-closed structure are disposed to the other end of the auxiliary temperature equilibration piping 222 for the gaseous or liquid state fluid to flow in and out. The fluid may perform convection circulation by the effects that the cooler descends and the hotter ascends, or driven by a motor with the installation of a liquid pump 123, or driven by other mechanical kinetics or by manual so to pump the fluid passing through the auxiliary temperature equilibration piping 222 into the fluid piping 221 to the interior space in the building 110 or other closed or semi-closed structure. The fluid flows through the fluid piping 231 back to the auxiliary temperature equilibration piping 222 so to indirectly perform the temperature equilibration transmission of indirect conduction of thermal energy between the water supply system and the interior space in the building 110 or a closed or semi-closed structure. The fluid piping 221 and another fluid piping 231 are respectively leading to the interior space in the building 110 or other closed or semi-closed structure to perform the open fluid circulation; and the optional filtration device 124 may be each disposed to the fluid inlet and outlet of the fluid piping 221 and another fluid piping 231.

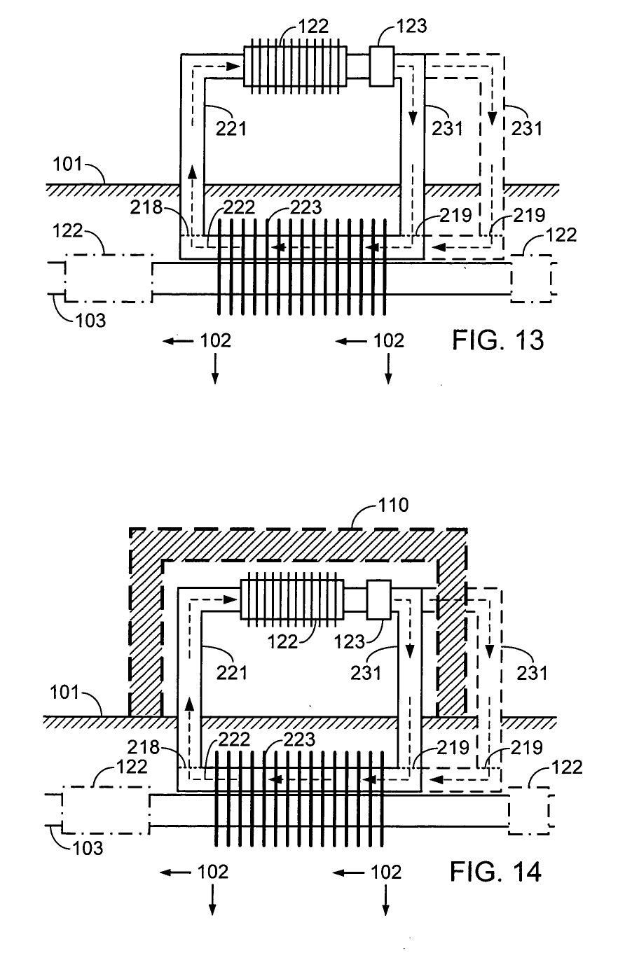

FIG. 13 shows a schematic view of another preferred embodiment yet of the present invention, wherein the water supply system is disposed with an auxiliary temperature equilibration piping in parallel to the present invention so to perform closed fluid circulation to an open space.

One or a plurality of auxiliary temperature equilibration piping 222 is disposed in parallel with and to the perimeter of a certain section of the underground water pipe 103 of the water supply system. The auxiliary temperature equilibration piping 222 is capable of executing transmission of thermal energy mutually with the underground water pipe 103 of the water supply system, and both may be made to share the same construction or interlocked to each other if and when necessarily to facilitate the transmission of thermal energy; or alternatively, a wing shape structure 223 or any other heat conduction structure or heat pipe device may be disposed at where between the water supply system and the auxiliary temperature equilibration piping 222 so to indirectly perform the indirect transmission of thermal energy between the water current inside the underground piping 103 of the water supply system and the fluid flowing though the auxiliary temperature equilibration piping 222. One or a plurality fluid inlet 218 and a fluid piping 221 leading to the open space are disposed to one end of the auxiliary temperature equilibration piping 222; and one or a plurality of fluid outlet 219 and a fluid piping 231 leading to the open space are disposed to the other end of the auxiliary temperature equilibration piping 222 for the gaseous or liquid state fluid to flow in and out. The fluid may perform convection circulation by the effects that the cooler descends and the hotter ascends, or driven by a motor with the installation of a liquid pump 123, or driven by other mechanical kinetics or by manual so to pump the fluid passing through the auxiliary temperature equilibration piping 222 into the fluid piping 221 to the temperature equilibrating installation 122 disposed in the open space. The fluid then flows through the fluid piping 231 back to the auxiliary temperature equilibration piping 222 so to indirectly perform the temperature equilibration transmission of indirect conduction of thermal energy between the water supply system and the open space through the temperature equilibrating installation 122. The fluid piping 221 and another fluid piping 231 are respectively leading to the temperature equilibrating installation 122 disposed in the open space of the subject matter to perform the closed fluid circulation for temperature equilibration.

FIG. 14 shows a schematic view of another preferred embodiment yet of the present invention, wherein the water supply system is disposed with an auxiliary temperature equilibration piping in parallel to the present invention so to perform closed fluid circulation to the interior space in a building or other closed or semi-closed structure.

One or a plurality of auxiliary temperature equilibration piping 222 is disposed in parallel with and to the perimeter of a certain section of the underground water pipe 103 of the water supply system. The auxiliary temperature equilibration piping 222 is capable of executing transmission of thermal energy mutually with the underground water pipe 103 of the water supply system, and both may be made to share the same construction or interlocked to each other if and when necessarily to facilitate the transmission of thermal energy; or alternatively, a wing shape structure 223 or any other heat conduction structure or heat pipe device may be disposed at where between the water supply system and the auxiliary temperature equilibration piping 222 so to indirectly perform the indirect transmission of thermal energy between the water current inside the underground piping 103 of the water supply system and the fluid flowing though the auxiliary temperature equilibration piping 222. One or a plurality fluid inlet 218 and a fluid piping 221 leading to the interior space in the building 110 or other closed or semi-closed structure are disposed to one end of the auxiliary temperature equilibration piping 222; and one or a plurality of fluid outlet 219 and a fluid piping 231 leading to the interior space in the building 110 or a closed or semi-closed structure are disposed to the other end of the auxiliary temperature equilibration piping 222 for the gaseous or liquid state fluid to flow in and out. The fluid may perform convection circulation by the effects that the cooler descends and the hotter ascends, or driven by a motor with the installation of a liquid pump 123, or driven by other mechanical kinetics or by manual so to pump the fluid passing through the auxiliary temperature equilibration piping 222 into the fluid piping 221 to the temperature equilibrating installation 122 disposed in the building 110 or other closed or semi-closed structure. The fluid flows through the fluid piping 231 back to cladding temperature equilibration chamber structure 220 so to indirectly perform the temperature equilibration transmission of indirect conduction of thermal energy between the water supply system and the interior space in the building 110 or a closed or semi-closed structure through the temperature equilibrating installation 122. The fluid piping 221 and another fluid piping 231 are respectively leading to the temperature equilibrating installation 122 disposed in the interior space in the building 110 or other closed or semi-closed structure to perform the closed fluid circulation for transmission of temperature equilibration.

The subject matter for the temperature equilibration operation performed by the methodology and installation of temperature equilibration with a water supply system of the present invention includes:

(1) Various types of open space; or

(2) Open space on the surface of earth; or

(3) Shallow stratum; or

(4) Interior space of a semi-closed or closed building; or

(5) Interior space of other semi-closed or closed structure.

The building referred in these preferred embodiments described above for the methodology and installation of temperature equilibration with a water supply system of the present invention includes house, warehouse, or any building in column or any other geometric form, or any other designated building comprised of a semi-closed or closed structure designed as desired. Other functioning for the general house to live in, the interior space may be further operated to accommodate:

(1) Tooling machine, test and inspection instruments, observation instruments, industrial facilities, mechanical facilities, power machineries, and electro-mechanical facilities that demands specific working temperature; or

(2) Cooling installations, electricity storage installations; or

(3) Storage of solid, liquid, or gaseous state chemicals.

With the present invention, the natural thermal energy from the water supply system either cools or maintains the installations and facilities in a certain range of temperature.

Accordingly, the methodology and installation of temperature equilibration with a water supply system of the present invention by operating on the natural thermal energy (ranging between 12˜16□) in the stratum absorbed by the underground water pipe of an existing water supply system to have current as a carrier to flow through a closed water pipe disposed at where closer to the surface of the earth, exposed from the ground or in a building to execute heat transmission of temperature equilibration to offer lower cost, summary work, and precise function; therefore, this application for a patent is duly filed.

1. A methodology and installation of temperature equilibration with a water supply system operates on having an underground water pipe of the conventional water supply system buried in the stratum and water running in the pipe as carriers to be incorporated with a flow passage comprised of a closed water pipe constructed on the ground, a temperature equilibrating object, and a pump. Whereas it is a well-known fact that the stratum 4˜6 meters below the surface of the earth maintains a normal temperature range between 12˜16? all year round, the current pumped by the pump, or the circulating current resulted from the convection effect due to temperature difference when the hotter water runs to the cooler water and vice versa, or the current resulted from shunting effect, functions in the present invention as a carrier of thermal energy to execute thermal transmission of temperature equilibration between the thermal energy in the stratum and a subject matter on ground to receive the thermal energy transmission, thus to replace or support the conventional air conditioning system that consumes massive energy and further to save energy.

2. A methodology and installation of temperature equilibration with a water supply system of claim 1 when applied in a building to provide the function of temperature equilibration is essentially comprised of:
an underground water pipe 103: buried in a deeper stratum 102 for transmission of current in the water supply system; the structure of the underground water pipe 103 may be in conventional form of pipe or in any geometric shape that facilitates heat transmission, and is made of material that provides good heat conduction such as metal or other heat conduction material to directly conduct the thermal energy in the stratum from the underground water pipe 103; furthermore, an optional item of temperature equilibrating installation 122 may be disposed in series with the underground water pipe 103 to improve conduction of the thermal energy in the stratum;
a closed water pipe 121: related to a closed current piping, may be structured in a conventional pipe form or any geometric shape and material that facilitates heat transmission, and disposed at where even closer to a surface of the earth 101 than that by the underground water pipe 103, where exposed from the surface of the earth 101, on top in a building 110, or in a selected space closer to the ground or to a wall; the inlet of the closed water pipe 121 is connected to the underground water pipe 103 to introduce the current from the underground water pipe 103 to flow through another section of the underground water pipe 103 connected to the outlet of the closed water pipe 121 before flowing back into the underground water pipe 103 to complete the flow passage in executing heat transmission of temperature equilibration by current; furthermore, an optional temperature equilibrating installation 122 and an optional pump 123 to pump the current may be provided in series as applicable;
the temperature equilibrating installation 122: made of material with good heat conduction structured in a geometric shape that facilitates heat conduction, includes a water inlet and water passage in the temperature equilibrating installation 122, and a water outlet; connected in series with the closed water pipe 121 in a building 110 or with the underground water pipe 103 to execute heat transmission of temperature equilibration with the thermal energy of the water passing by and that from the perimeter of the temperature equilibrating installation 122; the temperature equilibrating installation 122 may be provided as applicable to be connected in series to the underground water pipe 103 and/or the closed water pipe 121 in the building 110, or not provided at all; and
a pump 123: to pump the water flow to transmit thermal energy; may be of reciprocal or circulating pump driven by external force; the external force being selected according to the working environment includes the mechanical energy or the electric power converted from the mechanical energy generated from power motor, engine power, other wind velocity energy, thermal energy, temperature difference energy, or solar energy; furthermore, the pump 123 relates to an optional item to be provided or not provided as applicable.

3. A methodology and installation of temperature equilibration with a water supply system of claim 1 when applied in a shallow surface of the earth to provide the function of temperature equilibration is essentially comprised of:
an underground water pipe 103: buried in a deeper stratum 102 for transmission of current in the water supply system; the structure of the underground water pipe 103 may be in conventional form of pipe or in any geometric shape that facilitates heat transmission, and is made of material that provides good heat conduction such as metal or other heat conduction material to directly conduct the thermal energy in the stratum from the underground water pipe 103; furthermore, an optional item of temperature equilibrating installation 122 may be disposed in series with the underground water pipe 103 to improve conduction of the thermal energy in the stratum;
a closed water pipe 121: related to a closed current piping, may be structured in a conventional pipe form or any geometric shape and material that facilitates heat transmission, and disposed at where even closer to a surface of the earth 101 than that by the underground water pipe 103; the inlet of the closed water pipe 121 is connected to the underground water pipe 103 to introduce the current from the underground water pipe 103 to flow through another section of the underground water pipe 103 connected to the outlet of the closed water pipe 121 before flowing back into the underground water pipe 103 to complete the flow passage in executing heat transmission of temperature equilibration by current; furthermore, an optional temperature equilibrating installation 122 and an optional pump 123 to pump the current may be provided in series as applicable;
the temperature equilibrating installation 122: made of material with good heat conduction structured in a geometric shape that facilitates heat conduction, includes a water inlet and water passage in the temperature equilibrating installation 122, and a water outlet; connected in series with the closed water pipe 121 or with the underground water pipe 103 to execute heat transmission of temperature equilibration with the thermal energy of the water passing by and that from the perimeter of the temperature equilibrating installation 122; the temperature equilibrating installation may be provided as applicable to be connected in series to the underground water pipe 103 and/or the closed water pipe 121 in the building 110, or not provided at all; and
a pump 123: to pump the water flow to transmit thermal energy; may be of reciprocal or circulating pump driven by external force; the external force being selected according to the working environment includes the mechanical energy or the electric power converted from the mechanical energy generated from power motor, engine power, other wind velocity energy, thermal energy, temperature difference energy, or solar energy; furthermore, the pump 123 relates to an optional item to be provided or not provided as applicable.

4. A methodology and installation of temperature equilibration with a water supply system of claim 1 when applied in a subject matter exposed from the surface of the earth to provide the function of temperature equilibration is essentially comprised of:
an underground water pipe 103: buried in a deeper stratum 102 for transmission of current in the water supply system; the structure of the underground water pipe 103 may be in conventional form of pipe or in any geometric shape that facilitates heat transmission, and is made of material that provides good heat conduction such as metal or other heat conduction material to directly conduct the thermal energy in the stratum from the underground water pipe 103; furthermore, an optional item of temperature equilibrating installation 122 may be disposed in series with the underground water pipe 103 to improve conduction of the thermal energy in the stratum;
a closed water pipe 121: related to a closed current piping, may be structured in a conventional pipe form or any geometric shape and material that facilitates heat transmission, and disposed at where exposed from the surface of the earth 101; the inlet of the closed water pipe 121 is connected to the underground water pipe 103 to introduce the current from the underground water pipe 103 to flow through another section of the underground water pipe 103 connected to the outlet of the closed water pipe 121 before flowing back into the underground water pipe 103 to complete the flow passage in executing heat transmission of temperature equilibration by current; furthermore, an optional temperature equilibrating installation 122 and an optional pump 123 to pump the current may be provided in series as applicable;
the temperature equilibrating installation 122: made of material with good heat conduction structured in a geometric shape that facilitates heat conduction, includes a water inlet and water passage in the temperature equilibrating installation 122, and a water outlet; connected in series with the closed water pipe 121 or with the underground water pipe 103 to execute heat transmission of temperature equilibration with the thermal energy of the water passing by and that from the perimeter of the temperature equilibrating installation 122; the temperature equilibrating installation 122 may be provided as applicable to be connected in series to the underground water pipe 103 and/or the closed water pipe 121 in the building 110, or not provided at all; and
a pump 123: to pump the water flow to transmit thermal energy; may be of reciprocal or circulating pump driven by external force; the external force being selected according to the working environment includes the mechanical energy or the electric power converted from the mechanical energy generated from power motor, engine power, other wind velocity energy, thermal energy, temperature difference energy, or solar energy; furthermore, the pump 123 relates to an optional item to be provided or not provided as applicable.

5. A methodology and installation of temperature equilibration with a water supply system of claim 1 when applied at where in a structure on the top of a building to provide the function of temperature equilibration is essentially comprised of:
an underground water pipe 103: buried in a deeper stratum 102 for transmission of current in the water supply system; the structure of the underground water pipe 103 may be in conventional form of pipe or in any geometric shape that facilitates heat transmission, and is made of material that provides good heat conduction such as metal or other heat conduction material to directly conduct the thermal energy in the stratum from the underground water pipe 103; furthermore, an optional item of temperature equilibrating installation 122 may be disposed in series with the underground water pipe 103 to improve conduction of the thermal energy in the stratum;
a closed water pipe 121: related to a closed current piping, may be structured in a conventional pipe form or any geometric shape and material that facilitates heat transmission, and disposed in a structure on top of a building 110; the inlet of the closed water pipe 121 is connected to the underground water pipe 103 to introduce the current from the underground water pipe 103 to flow through another section of the underground water pipe 103 connected to the outlet of the closed water pipe 121 before flowing back into the underground water pipe 103 to complete the flow passage in executing heat transmission of temperature equilibration by current; furthermore, an optional temperature equilibrating installation 122 and an optional pump 123 to pump the current may be provided in series as applicable;
the temperature equilibrating installation 122: made of material with good heat conduction structured in a geometric shape that facilitates heat conduction, includes a water inlet and water passage in the temperature equilibrating installation 122, and a water outlet; connected in series with the closed water pipe 121 or with the underground water pipe 103 to execute heat transmission of temperature equilibration with the thermal energy of the water passing by and that from the perimeter of the temperature equilibrating installation 122; the temperature equilibrating installation 122 may be provided as applicable to be connected in series to the underground water pipe 103 and/or the closed water pipe 121 in the building 110, or not provided at all; and
a pump 123: to pump the water flow to transmit thermal energy; may be of reciprocal or circulating pump driven by external force; the external force being selected according to the working environment includes the mechanical energy or the electric power converted from the mechanical energy generated from power motor, engine power, other wind velocity energy, thermal energy, temperature difference energy, or solar energy; furthermore, the pump 123 relates to an optional item to be provided or not provided as applicable.

6. A methodology and installation of temperature equilibration with a water supply system of claim 1 when applied on top of a building to provide the function of temperature equilibration in open air is essentially comprised of:
an underground water pipe 103: buried in a deeper stratum 102 for transmission of current in the water supply system; the structure of the underground water pipe 103 may be in conventional form of pipe or in any geometric shape that facilitates heat transmission, and is made of material that provides good heat conduction such as metal or other heat conduction material to directly conduct the thermal energy in the stratum from the underground water pipe 103; furthermore, an optional item of temperature equilibrating installation 122 may be disposed in series with the underground water pipe 103 to improve conduction of the thermal energy in the stratum;
a closed water pipe 121: related to a closed current piping, may be structured in a conventional pipe form or any geometric shape and material that facilitates heat transmission, and disposed at where exposed from the top of the building 110; the inlet of the closed water pipe 121 is connected to the underground water pipe 103 to introduce the current from the underground water pipe 103 to flow through another section of the underground water pipe 103 connected to the outlet of the closed water pipe 121 before flowing back into the underground water pipe 103 to complete the flow passage in executing heat transmission of temperature equilibration by current; furthermore, an optional temperature equilibrating installation 122 and an optional pump 123 to pump the current may be provided in series as applicable;
the temperature equilibrating installation 122: made of material with good heat conduction structured in a geometric shape that facilitates heat conduction, includes a water inlet and water passage in the installation 122, and a water outlet; connected in series with the closed water pipe 121 exposed from a top of a building 110 or with the underground water pipe 103 to execute heat transmission of temperature equilibration with the thermal energy of the water passing by and that from the perimeter of the temperature equilibrating installation 122; the temperature equilibrating installation may be provided as applicable to be connected in series to the underground water pipe 103 and/or the closed water pipe 121 exposed from the top of in the building 110, or not provided at all, and
a pump 123: to pump the water flow to transmit thermal energy; may be of reciprocal or circulating pump driven by external force; the external force being selected according to the working environment includes the mechanical energy or the electric power converted from the mechanical energy generated from power motor, engine power, other wind velocity energy, thermal energy, temperature difference energy, or solar energy; furthermore, the pump 123 relates to an optional item to be provided or not provided as applicable.

7. A methodology and installation of temperature equilibration with a water supply system of claim 1, wherein, the temperature equilibrating effects include having the temperature of the subject matter on the surface of the earth to receive transmission of thermal energy reduced by the thermal energy of the stratum at comparatively lower temperature.

8. A methodology and installation of temperature equilibration with a water supply system of claim 1 wherein, the temperature equilibrating effects include having the temperature of the subject matter on the surface of the earth to receive transmission of thermal energy raised by the thermal energy of the stratum at comparatively higher temperature.

9. A methodology and installation of temperature equilibration with a water supply system of claim 1, wherein, the temperature equilibrating installation 122 may be optionally provided as follows:
(1) to be provided in the underground floor and connected in series with the underground water pipe 103; or
(2) to be provided at where closer to or exposed from the surface of the earth and connected in series with the closed water pipe 121; or
(3) to be connected in series with both of the underground water pipe 103 and the closed water pipe 121; or
(4) not to be provided to either the underground water pipe 103 or the closed water pipe 121.

10. A methodology and installation of temperature equilibration with a water supply system of claim 1, wherein the temperature equilibrating installation 122 of the methodology and installation of temperature equilibration with a water supply system of the present invention may be provided or not by taking the site of application and cost benefits into consideration; in addition to providing the temperature equilibrating installation 122, the temperature equilibrating function may be achieved by the underground water pipe 103 or the closed water pipe 121 or the closed water pipe in lieu of the temperature equilibrating installation 122; or a structure providing good thermal conduction performance is disposed other than the underground water pipe 103 or the closed water pipe 121 to promote temperature equilibrating function.

11. A methodology and installation of temperature equilibration with a water supply system of claim 1, wherein, to upgrade the general efficiency, heat insulation material may be provided as required by the work environment or function between the underground water pipe 103 and the closed water pipe 121 exposed or closer to the surface of the earth 101 for the methodology and installation of temperature equilibration with a water supply system of the present invention, or the section of the closed water pipe 121 is made of heat insulation material to prevent loss of thermal energy.

12. A methodology and installation of temperature equilibration with a water supply system of claim 1, wherein, the linking between the closed water pipe 121 and the underground water pipe 103 in the methodology and installation of temperature equilibration with a water supply system of the present invention may be as such that:
(1) The water inlet of the closed water pipe 121 is connected to the side of the upper stream; and the outlet, to the side of the lower stream of the underground water pipe 103, or
(2) The water inlet of the closed water pipe 121 is connected to the side of the lower stream; and the outlet, to the side of the upper stream of the underground water pipe 103.

13. A methodology and installation of temperature equilibration with a water supply system of claim 1, wherein other than the pump 123 to pump current in the methodology and installation of temperature equilibration with a water supply system of the present invention to serve as an optional item to function as a carrier of thermal energy by taking the application site and cost benefits into consideration, the water convection effects may be applied to create circulating water, or the flowing force of the current in the underground water pipe 103 is used to create shunting effect for the water flowing through the closed water pipe 121 to serve as a carrier of thermal energy to execute heat transmission of temperature equilibration; in addition to being pumped by the pump 123, the current flowing through the closed water pipe 121 may be found with any of the following patterns:
(1) the convection effects due to the fact that the cooler water descends and the hotter water ascends that create circulating water to serve as the carrier of thermal energy to execute heat transmission of temperature equilibration; or
(2) by following the direction of the current in the underground water pipe, the current indicates a specific angle that indicates positive water pressure when introduced into the water inlet connected to the upper stream of the closed water pipe 121; e.g., indicating a sharp angle <90° against the current direction of the underground water pipe 103 thus to facilitate introducing the current into the closed water pipe 121 while indicating a specific angle with negative water pressure against the direction of the current of the underground water pipe 103, e.g., an obtuse angle >90° to facilitate the water flowing out of the outlets of the closed water pipe 121 and to converge with the underground water pipe 103 in creating the shunting effects for the current branching out of the closed water pipe 121 to serve a carrier of thermal energy in executing heat transmission of temperature equilibration; or
(3) by relying upon the pump to pump the current and/or water temperature difference flowing characteristics of the water and/or shunting effects, the water flowing through the closed water pipe 121 serves as the carrier of the thermal energy to execute heat transmission of temperature equilibration.

14. A methodology and installation of temperature equilibration with a water supply system of claim 1, wherein the methodology and installation of temperature equilibration with a water supply system of the present invention may be applied at the same time to incorporate a water supply branch 104 to the closed water pipe 121 for certain portion of the conventional water supply branch 104 to serve as a common water pipe to create a closed current flow passage sharing the same structure with certain portion of the closed water pipe 121. If the pump 123 will be provided to the closed current passage sharing the common structure, then
(1) the pump 123 is disposed to the closed water pipe 121; or
(2) the pump 123 is disposed to the common water pipe; or
(3) both of the closed water pipe 121 and the common water pipe are respectively provided with the pump 123; or
(4) the pump 123 is provided neither to the closed water pipe 121 nor to the common water pipe.

15. A methodology and installation of temperature equilibration with a water supply system of claim 1, wherein, a cladding chamber structure for temperature equilibration is further provided to the ground or underground water supply piping of the water supply system of the present invention; indirectly through the interior of the cladding chamber, the thermal energy carried by the water current in the water supply piping flows to another gaseous or liquid state fluid of the subject matter into an open space, building, or other closed or semi-closed structure of the subject matter for temperature equilibration to perform the indirect transmission of thermal energy for the purpose of temperature equilibration.

16. A methodology and installation of temperature equilibration with a water supply system of claim 15, wherein the system includes a cladding chamber structure 220 for temperature equilibration disposed at where surrounds a certain section of the underground water pipe 103 of the water supply system; both end surfaces are closed to the cladding chamber structure 220 for temperature equilibration; one or a plurality of fluid inlet 218 and a fluid piping 221 leading to the open space are disposed at one end in the vicinity of the closed end surface; one or a plurality of fluid outlet 219 and a fluid piping 231 leading to the open space are disposed on the other end of the cladding chamber structure 220 to allow the gaseous or liquid state fluid flowing in and out; the fluid may perform convection circulation by the effects that the cooler descends and the hotter ascends, or driven by a motor with the installation of a liquid pump 123, or driven by other mechanical kinetics or by manual so to pump the fluid passing through the cladding chamber structure 220 into the fluid piping 221 to the open space; the fluid in the open space flows through the fluid piping 231 back to the cladding chamber structure 220 so to perform the temperature equilibration transmission of indirect conduction of thermal energy between the water supply system and the open space; the fluid piping 221 and another fluid piping 231 are respectively leading to the open space to perform the open fluid circulation; and the optional filtration device 124 may be each disposed to the fluid inlet and outlet of the fluid piping 221 and another fluid piping 231.

17. A methodology and installation of temperature equilibration with a water supply system of claim 15, wherein the system includes a cladding chamber structure 220 for temperature equilibration disposed at where surrounds a certain section of the underground water pipe 103 of the water supply system; both end surfaces are closed to the cladding chamber structure 220 for temperature equilibration; one or a plurality of fluid inlet 218 and the fluid piping 221 leading to the space inside the closed or semi-closed structure in the building 110 are disposed at one end in the vicinity of the closed end surface; one or a plurality of fluid outlet 219 and a fluid piping 231 leading to the space inside the closed or semi-closed structure in the building 110 are disposed on the other end of the cladding chamber structure 220 to allow the gaseous or liquid state fluid flowing in and out; the fluid may perform convection circulation by the effects that the cooler descends and the hotter ascends, or driven by a motor with the installation of a liquid pump 123, or driven by other mechanical kinetics or by manual so to pump the fluid passing through the cladding chamber structure 220 into the fluid piping 221 to the space inside the building 110 or other closed or semi-closed structure; the fluid then flows through the fluid piping 231 back to the cladding chamber structure 220 so to perform the temperature equilibration transmission of indirect conduction of thermal energy between the water supply system and the space inside the building 110 or other closed or semi-closed structure; the fluid piping 221 and another fluid piping 231 are respectively leading to the interior space in the building 110 or other closed or semi-closed structure to perform the open fluid circulation; and the optional filtration device 124 may be each disposed to the fluid inlet and outlet of the fluid piping 221 and another fluid piping 231.

18. A methodology and installation of temperature equilibration with a water supply system of claim 15, wherein, the system includes a cladding chamber structure 220 for temperature equilibration disposed at where surrounds a certain section of the underground water pipe 103 of the water supply system; both end surfaces are closed to the cladding chamber structure 220 for temperature equilibration; one or a plurality of fluid inlet 218 and the fluid piping 221 leading to the open space are disposed at one end in the vicinity of the closed end surface; one or a plurality of fluid outlet 219 and a fluid piping 231 leading to the open space are disposed on the other end of the cladding chamber structure 220 to allow the gaseous or liquid state fluid flowing in and out; the fluid may perform convection circulation by the effects that the cooler descends and the hotter ascends, or driven by a motor with the installation of a liquid pump 123, or driven by other mechanical kinetics or by manual so to pump the fluid passing through the cladding chamber structure 220 into the fluid piping 221 to the temperature equilibrating installation 122 disposed in the open space; the fluid then flows through the fluid piping 231 back to the cladding chamber structure 220 so to perform the temperature equilibration transmission of indirect conduction of thermal energy between the water supply system and the open space through the temperature equilibrating installation 122; the fluid piping 221 and another fluid piping 231 are respectively leading to the temperature equilibration device 122 disposed in the open space to perform the closed fluid circulation for transmission of temperature equilibration.

19. A methodology and installation of temperature equilibration with a water supply system of claim 15, wherein, the system includes a cladding chamber structure 220 for temperature equilibration disposed at where surrounds a certain section of the underground water pipe 103 of the water supply system; both end surfaces are closed to the cladding chamber structure 220 for temperature equilibration; one or a plurality of fluid inlet 218 and the fluid piping 221 leading to the interior space in a building 110 or a closed or semi-closed structure are disposed at one end in the vicinity of the closed end surface; one or a plurality of fluid outlet 219 and a fluid piping 231 leading to the interior space in a building 110 or a closed or semi-closed structure are disposed on the other end of the cladding chamber structure 220 to allow the gaseous or liquid state fluid flowing in and out; the fluid may perform convection circulation by the effects that the cooler descends and the hotter ascends, or driven by a motor with the installation of a liquid pump 123, or driven by other mechanical kinetics or by manual so to pump the fluid passing through the cladding chamber structure 220 into the fluid piping 221 to the temperature equilibrating installation 122 disposed in the interior space in the building 110 or other closed or semi-closed structure; the fluid then flows through the fluid piping 231 back to the cladding chamber structure 220 so to perform the temperature equilibration transmission of indirect conduction of thermal energy between the water supply system and the interior space in the building 110 or other closed or semi-closed structure through the temperature equilibrating installation 122; the fluid piping 221 and another fluid piping 231 are respectively leading to the temperature equilibrating installation 122 disposed in the interior space in the building 110 or other closed or semi-closed structure to perform the closed fluid circulation for transmission of temperature equilibration.

20. A methodology and installation of temperature equilibration with a water supply system of claim 1, wherein, an auxiliary temperature equilibration piping may be included in the methodology and installation of temperature equilibration with a water supply system of the present invention to be disposed at where in parallel and allowing mutual transmission of thermal energy with the ground or the underground water supply piping; the auxiliary temperature equilibration piping is provided also to allow another type of gaseous or liquid state fluid passing through the piping to the subject matter to indirectly perform the temperature equilibration transmission with the subject matter by utilizing the thermal energy carried by the water current inside the water supply piping of the underground water supply system.

21. A methodology and installation of temperature equilibration with a water supply system of claim 20, wherein, the system includes one or a plurality of an auxiliary temperature equilibration piping 222 disposed in parallel with and to the perimeter of a certain section of the underground water pipe 103 of the water supply system that is capable of executing transmission of thermal energy mutually with the underground water pipe 103 of the water supply system, and both may be made to share the same construction or interlocked to each other if and when necessarily to facilitate the transmission of thermal energy; or alternatively, a wing shape structure 223 or any other heat conduction structure or heat pipe device may be disposed at where between the water supply system and the auxiliary temperature equilibration piping 222 so to indirectly perform the indirect transmission of thermal energy between the water current inside the underground piping 103 of the water supply system, and the fluid flowing through the auxiliary temperature equilibration piping 222; one or a plurality fluid inlet 218 and a fluid piping 221 leading to the open space are disposed to one end of the auxiliary temperature equilibration piping 222; and one or a plurality of fluid outlet 219 and a fluid piping 231 leading to the open space are disposed to the other end of the auxiliary temperature equilibration piping 222 for the gaseous or liquid state fluid to flow in and out; the fluid may perform convection circulation by the effects that the cooler descends and the hotter ascends, or driven by a motor with the installation of a liquid pump 123, or driven by other mechanical kinetics or by manual so to pump the fluid passing through the auxiliary temperature equilibration piping 222 into the fluid piping 221 to the open space; the fluid then flows through the fluid piping 231 back to the auxiliary temperature equilibration piping 222 so to indirectly perform the temperature equilibration transmission of indirect conduction of thermal energy between the water supply system and the open space; the fluid piping 221 and another fluid piping 231 are respectively leading to the open space to perform the open fluid circulation; and the optional filtration device 124 may be each disposed to the fluid inlet and outlet of the fluid piping 221 and another fluid piping 231.

22. A methodology and installation of temperature equilibration with a water supply system of claim 20, wherein, one or a plurality of auxiliary temperature equilibration piping 222 is disposed in parallel with and to the perimeter of a certain section of the underground water pipe 103 of the water supply system; the auxiliary temperature equilibration piping 222 is capable of executing transmission of thermal energy mutually with the underground water pipe 103 of the water supply system, and both may be made to share the same construction or interlocked to each other if and when necessarily to facilitate the transmission of thermal energy; or alternatively, a wing shape structure 223 or any other heat conduction structure or heat pipe device may be disposed at where between the water supply system and the auxiliary temperature equilibration piping 222 so to indirectly perform the indirect transmission of thermal energy between the water current inside the underground piping 103 of the water supply system and the fluid flowing though the auxiliary temperature equilibration piping 222; one or a plurality fluid inlet 218 and a fluid piping 221 leading to the interior space in the building 110 or other closed or semi-closed structure are disposed to one end of the auxiliary temperature equilibration piping 222; and one or a plurality of fluid outlet 219 and a fluid piping 231 leading to the interior space in the building 110 or a closed or semi-closed structure are disposed to the other end of the auxiliary temperature equilibration piping 222 for the gaseous or liquid state fluid to flow in and out; the fluid may perform convection circulation by the effects that the cooler descends and the hotter ascends, or driven by a motor with the installation of a liquid pump 123, or driven by other mechanical kinetics or by manual so to pump the fluid passing through the auxiliary temperature equilibration piping 222 into the fluid piping 221 to the interior space in the building 110 or other closed or semi-closed structure; the fluid flows through the fluid piping 231 back to the auxiliary temperature equilibration piping 222 so to indirectly perform the temperature equilibration transmission of indirect conduction of thermal energy between the water supply system and the interior space in the building 110 or a closed or semi-closed structure; the fluid piping 221 and another fluid piping 231 are respectively leading to the interior space in the building 110 or other closed or semi-closed structure to perform the open fluid circulation; and the optional filtration device 124 may be each disposed to the fluid inlet and outlet of the fluid piping 221 and another fluid piping 231.

23. A methodology and installation of temperature equilibration with a water supply system of claim 20, wherein, one or a plurality of auxiliary temperature equilibration piping 222 is disposed in parallel with and to the perimeter of a certain section of the underground water pipe 103 of the water supply system; the auxiliary temperature equilibration piping 222 is capable of executing transmission of thermal energy mutually with the underground water pipe 103 of the water supply system, and both may be made to share the same construction or interlocked to each other if and when necessarily to facilitate the transmission of thermal energy; or alternatively, a wing shape structure 223 or any other heat conduction structure or heat pipe device may be disposed at where between the water supply system and the auxiliary temperature equilibration piping 222 so to indirectly perform the indirect transmission of thermal energy between the water current inside the underground piping 103 of the water supply system and the fluid flowing though the auxiliary temperature equilibration piping 222. One or a plurality fluid inlet 218 and a fluid piping 221 leading to the open space are disposed to one end of the auxiliary temperature equilibration piping 222; and one or a plurality of fluid outlet 219 and a fluid piping 231 leading to the open space are disposed to the other end of the auxiliary temperature equilibration piping 222 for the gaseous or liquid state fluid to flow in and out; the fluid may perform convection circulation by the effects that the cooler descends and the hotter ascends, or driven by a motor with the installation of a liquid pump 123, or driven by other mechanical kinetics or by manual so to pump the fluid passing through the auxiliary temperature equilibration piping 222 into the fluid piping 221 to the temperature equilibrating installation 122 disposed in the open space; the fluid then flows through the fluid piping 231 back to the auxiliary temperature equilibration piping 222 so to indirectly perform the temperature equilibration transmission of indirect conduction of thermal energy between the water supply system and the open space through temperature equilibrating installation 122; the fluid piping 221 and another fluid piping 231 are respectively leading to the temperature equilibrating installation 122 disposed in the open space of the subject matter to perform the closed fluid circulation for temperature equilibration.

24. A methodology and installation of temperature equilibration with a water supply system of claim 20, wherein, one or a plurality of auxiliary temperature equilibration piping 222 is disposed in parallel with and to the perimeter of a certain section of the underground water pipe 103 of the water supply system; the auxiliary temperature equilibration piping 222 is capable of executing transmission of thermal energy mutually with the underground water pipe 103 of the water supply system, and both may be made to share the same construction or interlocked to each other if and when necessarily to facilitate the transmission of thermal energy; or alternatively, a wing shape structure 223 or any other heat conduction structure or heat pipe device may be disposed at where between the water supply system and the auxiliary temperature equilibration piping 222 so to indirectly perform the indirect transmission of thermal energy between the water current inside the underground piping 103 of the water supply system and the fluid flowing though the auxiliary temperature equilibration piping 222; one or a plurality fluid inlet 218 and a fluid piping 221 leading to the interior space in the building 110 or other closed or semi-closed structure are disposed to one end of the auxiliary temperature equilibration piping 222; and one or a plurality of fluid outlet 219 and a fluid piping 231 leading to the interior space in the building 110 or a closed or semi-closed structure are disposed to the other end of the auxiliary temperature equilibration piping 222 for the gaseous or liquid state fluid to flow in and out; the fluid may perform convection circulation by the effects that the cooler descends and the hotter ascends, or driven by a motor with the installation of a liquid pump 123, or driven by other mechanical kinetics or by manual so to pump the fluid passing through the auxiliary temperature equilibration piping 222 into the fluid piping 221 to the temperature equilibrating installation 122 disposed in the building 110 or other closed or semi-closed structure; the fluid flows through the fluid piping 231 back to cladding temperature equilibration chamber structure 220 so to indirectly perform the temperature equilibration transmission of indirect conduction of thermal energy between the water supply system and the interior space in the building 110 or a closed or semi-closed structure through the temperature equilibrating installation 122; the fluid piping 221 and another fluid piping 231 are respectively leading to the temperature equilibrating installation 122 disposed in the interior space in the building 110 or other closed or semi-closed structure to perform the closed fluid circulation for transmission of temperature equilibration.

25. A methodology and installation of temperature equilibration with a water supply system of claim 1, 15 or 20, wherein, the subject matter for the temperature equilibration operation performed by the methodology and installation of temperature equilibration with a water supply system of the present invention includes:
(1) various types of open space; or
(2) open space on the surface of earth; or
(3) shallow stratum; or
(4) interior space of a semi-closed; or
(5) closed building or interior space of other semi-closed or closed structure.

26. A methodology and installation of temperature equilibration with a water supply system of claim 1, 15 or 20, wherein the building includes house, warehouse, or any building in column or any other geometric form, or any other designated building comprised of a semi-closed or closed structure designed as desired; other functioning for the general house to live in, the interior space may be further operated to accommodate:
(1) industrial facilities, mechanical facilities, power machineries, and electromechanical facilities that demands specific working temperature; or
(2) cooling installations, electricity storage installations; or
(3) storage of solid, liquid, or gaseous state chemicals;
(4) with the present invention, the natural thermal energy from the water supply system either cools or maintains the installations and facilities in a certain range of temperature.
